(19) United States
(12) Patent Application Publication
(10) Pub. No.: US 2004/0126460 A1
(43) Pub. Date: Jul. 1, 2004

(54) Nutritional mineral supplements from plant ash

(76) Inventor: Gerhard N. Schrauzer, Coronado, CA (US)

Correspondence Address: RICHARD D. CLARKE, LAW OFFICE OF RICHARD D. CLARKE, 3755 AVOCADO BLVD., #1000, LA MESA, CA, 91941-7301, US

(21) Appl. No.: 10/625,138

(22) Filed: Jul. 23, 2003

Related U.S. Application Data
(60) Provisional application No. 60/400,618, filed on Aug. 1, 2002.

(51) Int. Cl. A23L 1/30

(52) U.S. Cl. 426/72

(57) ABSTRACT

A method by which plant ash is reacted with individual acids or mixtures of acids to obtain the naturally occurring minerals and trace elements from the ash for the purpose of producing palatable mineral supplements for consumption by humans and animals. Uncontaminated plant material can be specifically selected for high concentrations of certain minerals to provide specific supplements high in the desired mineral or minerals. Additional ingredients can be added to said mineral supplements, such as vitamins, herbal extracts, bioflavonoids, nutraceuticals, antioxidants, natural or artificial sweeteners, thickeners, fragrances, food colorings, and stabilizing agents, such as grape seed extract or benzoic acid to increase nutritional value, improve taste, flavor, appearance, consistency and shelf life. Additionally, the minerals can be packaged in a tablet form such that when dropped into water or juice will produce CO₂ gas causing the solution to effervesce resulting in a mineral supplement in the form of a refreshing carbonated drink.

### CROSS REFERENCE TO RELATED APPLICATIONS

This application claims the benefit of U.S. Provisional Application Serial No. 60/400,618 filed on Aug. 1, 2002.

### BACKGROUND OF INVENTION

1. Field of the Invention

The present invention relates to a method for preparing mineral supplements which utilize plant ash as the source of both the essential elements and the beneficial elements. Plant ash is readily available at low cost and contains all elements higher animals and humans require or are adapted to use, in total more than 60 elements.

2. Description of the Related Art

The use of plant ash, or more particularly of juniper ash and eucalyptus tree ash, as the starting material for a nutritional mineral supplement has not been the subject of previous patent applications. In U.S. Pat. No. 4,469,503, issued to R. F. Stoeckel, coal ash is claimed as component of a fertilizer composition in combination with a slow-release nitrogen fertilizer. In U.S. Pat. No. 5,451,240, issued to R. Trowbridge, a process of preparation of compositions for stimulating plant growth is claimed, whereby coal ash is fused with a humic acid-bearing ore; particularly, fly ash is fused with leonardite to obtain compositions for stimulating plant growth.

The present invention does not relate to or claim coal ash in any way. Coal ash greatly differs in chemical composition from living plant ash in that it may contain high levels of toxic elements from the weathering of various ores and rocks, rendering it unsuitable for use in mineral supplements for humans or animals. Arsenic contents, for example, as quoted in the patent documents of Stoeckel and of Trowbridge, may range from 280 to 10,000 ppm, barium, from 18 to 2,200 ppm, and lead, from 200 to 31,000 ppm.

Therefore, it would be highly desirable to have a method for obtaining the minerals from ash in a manner suitable for consumption by humans and animals without the poisonous side effects of the above described patents.

A number of elements and minerals are required for the development, growth and reproduction of animals and humans. These elements are normally present in foods and are referred to as “essential” elements and minerals. To assure an adequate supply of these elements in human and animal nutrition, various types of dietary supplements are available. These supplements tend to be incomplete in the sense that they contain only the elements presently recognized as essential. Ideally, a “complete” mineral supplement should contain all nutritional elements, including those not recognized as essential but known to have beneficial effects on the organism.

Plant ash appears not to have been utilized specifically for the manufacture of mineral supplements, but its use for cooking and baking probably goes back thousands of years. In North America, for example, the Navajo Indians added ash from branches and needles of the juniper tree (Juniperus monosperma), tumble weed (Salsola sp.) and/or grease wood to corn and wheat flour for bread making. They also consumed Juniper tree ash in tea to treat digestive and stomach ailments.

In Table 1., the percent (%) composition of Juniper Ash with respect to major elements is given, revealing calcium as the major mineral element present.

TABLE 1
ELEMENTS IN JUNIPER ASH

| | (%) | | μg/g | | μg/g | | μg/g |
|---|---|---|---|---|---|---|---|
| Ca | 26.5 | Li | 32 | Be | 0.12 | B | 331 |
| K | 7.9 | V | 16 | Cr | 6.9 | Co | 4.1 |
| P | 2.1 | Ni | 43 | Cu | 90 | Zn | 335 |
| Mg | 1.6 | As | 1.7 | Se | 52 | Sr | 2493 |
| Fe | 0.16 | Zr | 1.2 | Mo | 0.20 | Cd | 0.20 |
| Mn | 0.15 | Sn | 0.019 | Sb | 0.027 | I | 0.73 |
| Na | 0.12 | Ba | 1239 | W | 0.148 | Pt | 0.008 |
| Al | 1.3 | Hg | 0.037 | Tl | 0.026 | Pb | 1.21 |
| S | 0.59 | Bi | 0.299 | Th | 0.376 | U | 0.095 |
| Si | 0.05 | Ce | 4.4 | Cs | 0.03 | Dy | 0.73 |
| | | Er | 0.33 | Eu | 0.41 | Gd | 0.98 |
| | | Ge | 0.22 | Hf | 0.02 | Ho | 0.15 |
| | | In | 0.01 | La | <0.01 | Nd | 5.0 |
| | | Nb | <0.05 | Os | <0.05 | Pr | 1.4 |
| | | Re | <0.05 | Rh | 0.090 | Rb | 13.0 |
| | | Ru | <0.05 | Sm | 0.79 | Ta | <0.01 |
| | | Te | <0.05 | Tb | 0.13 | Tu | 0.05 |
| | | Yb | 0.26 | Yt | 6.4 | Ti | 6.6 |
| | | Ga | 0.034 | | | | |

Juniper tree ash is still today an important source of calcium in the Navajo diet, as was shown in a recent study. However, as may be seen from Table 1, Juniper tree ash also provides nutritionally significant amounts of potassium, phosphorus, iron, copper, zinc, magnesium, manganese, sodium, phosphorus and a large number of trace and ultra trace elements. Additionally, the concentrations of toxic elements are quite low in Juniper tree, thus this ash could serve as source of virtually all essential and beneficial minerals and elements.

Therefore, it would be highly desirable to have a method for obtaining the minerals from plant ash in a manner suitable for consumption by humans and animals.

The ash from other plants may also be used if it is derived from plants growing in regions free of environmental contamination. The composition of plant ash varies with location, as well as, with the species from which the ash is derived.

In Table 2., the composition of Eucalyptus tree ash is given, revealing that it contains potassium as the major mineral element present.

TABLE 2
ELEMENTS IN EUCALYPTUS TREE ASH

| | (%) | | μg/g | | μg/g | | μg/g |
|---|---|---|---|---|---|---|---|
| Ca | 8.75 | Li | 36.4 | Be | 0.012 | B | 93 |
| K | 31.9 | V | 1.9 | Cr | 2.32 | Co | 0.28 |
| P | 3.83 | Ni | 8.5 | Cu | 20 | Zn | 88 |
| Mg | 3.70 | As | 0.055 | Se | 0.98 | Sr | 184 |
| Fe | 0.056 | Zr | 0.25 | Mo | 21 | Cd | 0.30 |
| Mn | 0.057 | Sn | 2.0 | Sb | 0.61 | I | 1.4 |
| Na | 1.47 | Ba | 123 | W | 0.21 | Pt | 0.009 |
| Al | 0.94 | Hg | 0.034 | Tl | 0.003 | Pb | 0.86 |
| S | 0.29 | Bi | 0.053 | Th | 0.28 | U | 0.13 |
| Si | 0.05 | Ce | 1.0 | Cs | 0.31 | Dy | 0.079 |
| | | Er | 0.036 | Eu | 0.033 | Gd | 0.092 |
| | | Ge | 0.089 | Hf | <0.01 | Ho | 0.15 |
| | | In | 0.01 | La | <0.01 | Nd | 0.47 |
| | | Nb | 0.009 | Os | <0.01 | Pr | 0.15 |
| | | Re | 0.006 | Rh | 0.012 | Rb | 33 |
| | | Ru | 0.001 | Sm | 0.080 | Ta | <0.01 |
| | | Te | <0.01 | Tb | 0.013 | Tu | 0.005 |
| | | Yb | <0.01 | Yt | 0.42 | Ti | 13 |
| | | Ga | 13 | | | | |

It is possible, therefore, to use specific plants as sources of certain elements, or blends from different plants, to obtain different elements in specific desired ratios. As may be seen from Tables 1. and 2., the ashes from plants grown in uncontaminated regions contain only trace amounts of toxic elements.

In Table 3., the percent (%) composition of Sea Kelp with respect to major elements is given, revealing iodine as the major mineral element present.

TABLE 3
ELEMENTS IN SEA KELP

| | (%) | | μg/g |
|---|---|---|---|
| Calcium (Ca) | 1.7 | Iodine (I) | 927 |
| Potassium (K) | 2.5 | Manganese (Mn) | 33 |
| Sulphur (S) | 2.8 | Tin (Sn) | 6.5 |
| Phosphorus (P) | 0.3 | Selenium (Se) | 4.9 |
| Nitrogen (N) | 1.4 | Cobalt (Co) | 4.5 |
| Magnesium (Mg) | 0.76 | Copper (Cu) | 4.0 |
| Iron (Fe) | 0.06 | | |
| Sodium (Na) | 4.21 | | |
| Aluminum (Al) | 0.03 | | |
| Chloride (Cl) | 6.5 | | |

Accordingly, the ashes from such plants or blends thereof are also suitable for supplement use. For example, when a plant is known to be high in a certain mineral, such as the relatively high concentration of Iodine in Sea Kelp, then blends of Sea Kelp ash with other plant ash or vitamins can be formulated to provide for more Iodine in the mineral/vitamin supplement. In this way, specific types of plant ash may be combined to result in supplements targeted for certain minerals prevalent in such plants.

However, because of the strongly caustic properties, plant ash cannot be consumed directly and must first be chemically modified to render it palatable. The present invention describes a method for converting ash from plants, such as juniper, into nutritional mineral supplements for humans and animals.

### SUMMARY OF INVENTION

Therefore, the principal object of the present invention is to provide a new and improved method by which plant ash is reacted with individual organic or inorganic acids or mixtures of organic and/or inorganic acids to obtain the naturally occurring minerals and trace elements from the ash for the purpose of producing mineral supplements for human and animal consumption.

It is a further object of the present invention to use chemical processing means such that the minerals can be recovered from the ash and prepared for consumption by humans and animals.

It is yet a further object of the present invention to describe a method of preparation of mineral supplements by reacting ash from plants with organic or inorganic acids or with mixtures of organic and/or inorganic acids, including but not limited to: lactic acid, citric acid, acetic acid, malic acid, gluconic acid, saccharic acid, orotic acid and ascorbic acid. Other natural sources of organic acids include citrus fruit, certain tropical fruits and fermentation products. The acid salts of the plant ash minerals thus produced may either be isolated in solid form or offered in solutions or suspensions.

It is yet a further object of the present invention that the ash of a single plant type or mixtures of several different plant types, or of the same plant type from different locations may be blended to achieve a mineral supplement enriched in certain minerals/elements or a uniform mineral/element composition. For example, the ash from marine plants, such as kelp, may be mixed with ash from terrestrial plants to increase the iodine content of the supplement.

It is a further object of the present invention that in principle, the ash of all higher plants qualify for use in nutritional supplements. However, only plants growing in unpolluted environments which have never been exposed to or sprayed with pesticides, herbicides, fire-retardants or other chemicals should be used.

Briefly, the above and further objects of the present invention are realized by providing a new and improved method for the production of specialized varying mineral and trace element plant ash compositions, and by which plant ash is reacted with individual acids or mixtures of acids to obtain the naturally occurring minerals and trace elements from the ash for the purpose of producing mineral supplements for human and animal consumption.

In the preferred method for obtaining nutritional supplements from plant ash, ash from the Juniper tree is reacted with lactic acid causing the formation of lactates in solution, which can be used as a liquid mineral supplement. Juniper tree ash can also be reacted with citric acid to yield solid citrates for use in tableted or powdered supplements. As needed or desired, additional ingredients can be added, such as vitamins, herbal extracts, bioflavonoids, nutraceuticals, antioxidants, natural or artificial sweeteners, thickeners, fragrances, food colorings, and stabilizing agents, such as grape seed extract or benzoic acid to increase nutritional value, improve taste, flavor, appearance, consistency and shelf life. Additionally, the minerals can be packaged in a tablet form such that when dropped into water (or juice) will produce CO₂ gas causing the solution to effervesce or “fizz” resulting in a mineral supplement in the form of a refreshing carbonated drink.

### DETAILED DESCRIPTION OF THE INVENTION

Plants are composed of many elements including the minerals that are drawn into the plant for nourishment. After a plant has been harvested and burned the ash that remains retains many of the minerals drawn into the plant for nourishment. These minerals are useful for providing a dietary supplement in humans, but because of the physical characteristics of the ash, the direct consumption of the unpalatable ash is prohibitive. Through chemical processing the minerals can be recovered from the ash and prepared for consumption by humans and animals.

The reaction of plant ash with aqueous organic and inorganic acids yield solutions of the salts or complexes of the elements within the corresponding acid. Acids which can be used for said purpose include, but are not restricted to, lactic acid, citric acid, malic acid, acetic acid, gluconic acid, saccharic acid, orotic acid and ascorbic acid. The reaction can be conducted with single acids, as well as with mixtures of different acids. Synthetic acids as well as acids from natural sources, such as fruit, or as obtained by fermentation processes may be used.

The reaction of the plant ash with the acids occurs with evolution of carbon dioxide and may be conducted at temperatures ranging from 0° to 100° C., preferably between 30° and 100° C. The resulting solutions may be diluted and used as liquid mineral supplements. To these solutions vitamins and other ingredients such as sugar, honey, artificial sweeteners, flavors, herbal extracts, fragrances, food colorings and stabilizing agents such as benzoic acid and grape seed extract may be added. For use in tableted mineral supplements the plant ash mineral salts may also be isolated as solids by evaporating the solutions.

Plant ash derived mineral supplements are especially suitable for the treatment and prevention of osteoporosis, to stimulate bone growth and to accelerate bone re-calcification. Unlike conventional calcium supplements, which contain only calcium, plant ash derived supplements contain additional naturally occurring minerals and trace elements which are known to be incorporated into bones and are required for bone growth, maintenance and overall bone health.

Specifically to be noted in this context are the elements strontium, calcium, magnesium, zinc, copper and other elements known to be necessary or beneficial for bone health. Strontium has been shown to replace a small proportion of calcium in hydroxyl apatite resulting in increased bone strength and resistance to resorption.

Additionally, elements present in plant ash, as described in the present disclosure, will also help prevent dental caries.

Another preferred method of converting plant ash into a potable solution is to treat the ash in an aqueous suspension with carbon dioxide (CO₂) which when packaged in a tablet form will, when dropped into water (or juices and numerous other beverages), produce CO₂ gas causing the solution to effervesce or “fizz” resulting in a carbonated mineral supplement in the form of a refreshing drink.

In another use for this novel intention a supplement for animal feed may be produced from plant ash, which provides all of the elements and minerals necessary for heathy growth and development of pets, as well as food producing animals and livestock.

### DESCRIPTION OF THE PREFERRED EMBODIMENTS

### Embodiment I

In the preferred embodiment, a solid mineral supplement is obtained by mixing, typically, 50 grams of juniper tree ash with 80 milliliters (ml) of citric acid in 200 ml water. The mixture is stirred and heated to between 30° C. and 100° C. until the reaction is complete. Note, in all of the described Embodiments the reaction time may vary with the temperature. The reaction solution is then evaporated to dryness. The remaining residue is ground and homogenized and can be used as a nutritional multi-mineral supplement. One gram of this residue typically contains 150 milligrams (mg) of calcium, 45 mg of potassium, 8 mg of magnesium, 1 mg of iron, 0.9 mg of manganese, 0.16 mg of zinc, 0.04 mg of copper, 0.1 mg of boron, and 50+ additional trace elements. This product can be used as a specialty mineral supplement or, alternatively, it can be formulated with vitamins, nutraceuticals, and herbs, as a multivitamin/multi-mineral supplement.

### Embodiment II

In another embodiment powdered Juniper ash, typically 50 parts, is added in batches under stirring to 400 parts of warm (40° C.-80° C.) of 25% glycerophosphoric acid solution in water. After all of the ash has been added, the resulting slurry is warmed for an additional 25 minutes and excess water is evaporated under reduced pressure. The dry residue consists of partially hydrated forms of glycerophosphates of calcium, potassium, magnesium and other inorganic elements present in Juniper wood ash. It can be used in aqueous suspension or in powdered form as a mineral supplement for humans and animals.

### Embodiment III

For the preparation of a liquid multi-mineral supplement, 50 grams of juniper tree ash are reacted with 500 ml of 25% aqueous lactic acid at 30°-100° C. Upon completion of the reaction, the solution is filtered and its volume is increased to approximately 1 liter with water. Natural or artificial sweeteners, fragrances, food colorings may be added for taste and appearance, benzoic acid or sodium benzoate (0.02%-0.5%) and sodium bisulfite (0.02%-0.5%) as preservatives. One fluid ounce of this solution typically provides 400 mg of calcium 140 mg of potassium, 25 mg of magnesium, 4 mg iron, and 50+ other trace and ultra trace elements.

### Embodiment IV

In another embodiment, typically, 50 grams of powdered eucalyptus tree ash is gradually added under stirring to 250 ml of 10% lime juice and the reaction is brought to completion by brief heating of approximately 30 minutes (or as necessary) to 80° C. The mixture is evaporated, preferably by freeze-drying to preserve aroma. The resulting solid, which consists primarily of the citrates of the plant mineral elements, is powdered and homogenized and is ready for use as a multi-mineral supplement or for further processing as delineated in Embodiment I, above.

### Embodiment V

In another embodiment powdered pine tree ash, typically, 50 grams, is added in batches to 125 ml of glucaric acid diluted in 400 ml water. The reaction is completed by heating the mixture to approximately 80° C. followed by evaporation of the solvent acid. The resulting solid residue is powdered, homogenized and tableted or processed further as described in Embodiment I, above.

### Embodiment VI

In another embodiment 50 grams of powdered grease wood tree ash is added in batches to 100 ml. of orotic acid in 400 ml water. The reaction is completed by heating the mixture to 80° C. for a period of approximately 30 minutes, followed by evaporation of the solvent acid. The resulting solid residue is powdered and homogenized for use as a mineral supplement for humans and animals.

### Embodiment VII

In another embodiment powdered mesquite ash, typically, 50 grams is added in batches to 100 ml of malic acid diluted in 400 ml water. The reaction is completed by heating the mixture to 80° C. for a period of approximately 30 minutes, followed by evaporation of the solvent. The resulting solid residue is powdered and homogenized for use of a mineral supplement for humans and animals.

### Embodiment VIII

In another embodiment 50 grams of powdered tumble weed ash is reacted with 130 grams of a 2:1 (weight/weight) mixture of lactic acid and ascorbic acid in 250 ml. of water under stirring at approximately 50° C. The reaction solution is then diluted to a volume of 500 ml with water and filtered, affording a solution containing the ascorbates and lactates of tumble weed ash. The solution is oxygen and light sensitive and should be stored in tinted containers under exclusion of air.

### Embodiment IX

In another embodiment a blend of plant ash from different sources, typically, 50 grams, is reacted with 1 liter of a 5% solution of apple cider vinegar at room temperature, approximately 25° C. After completion of the reaction the solution is filtered, affording a clear solution of plant ash minerals for use as a nutritional supplement.

### Embodiment X

A supplement specifically intended for the prevention an treatment of osteoporosis consisting of plant ash derived mineral salts according to Embodiment I, above, formulated to provide a per dosage unit of 200 international units of emulsified vitamin D₃, 400 mg of calcium, 1-15 mg of strontium, 1-15 mg of boron and all other major and minor trace elements present in plant ash.

### Embodiment XI

A liquid supplement specifically intended for the prevention and treatment of osteoporosis consisting of a solution of plant ash derived mineral salts according to Embodiment II, above, formulated to provide a per dosage unit of 200 international units of emulsified vitamin D₃, 400 mg of calcium, 25 mg magnesium, 5 mg zinc, 1-15 mg of strontium, 1-5 mg of boron, 1-2 mg copper and all other major and minor trace elements present in plant ash.

### Embodiment XII

A supplement specifically intended for the prevention an treatment of dental caries consisting of plant ash derived mineral salts according to Embodiment I, above, formulated to provide a per dosage unit of 200 international units of emulsified vitamin D₃, 400 mg of calcium, 1-5 mg of strontium, 1-15 mg of boron, and all other major and minor trace elements present in plant ash, with and/or without added sodium fluoride at levels of 1 to 5 mg per dosage unit.

### Embodiment XIII

A liquid supplement specifically intended for the prevention an treatment of osteoporosis consisting of a solution of plant ash derived mineral salts according to Embodiment II, above, formulated to provide a per dosage unit of 200 international units of emulsified vitamin D₃, 400 mg of calcium, 1-15 mg of strontium, 1-5 mg of boron and all other major and minor trace elements present in plant ash, with and/or without added sodium fluoride at levels of 1 to 5 mg per dosage unit.

### Embodiment XIV

Preferred embodiment wherein ash from marine plants, such as kelp, to provide a natural source of iodine, which is then used in combination with the above described Embodiments to provide a nutritional supplement with naturally occurring iodine.

While certain specific ingredients, proportions and methods are described in the above Embodiments which point out certain preferred embodiments of this novel invention, these may be varied, where suitable, with similar results. Other variations of these applications will occur to those skilled in the art upon reading this disclosure. Those variations and alternate applications are intended to be included within the scope of the present invention to the full extent indicated by the broad general meaning of the terms in which the appended claims are expressed.

I claim:

1. A method for preparing a consumable nutritional mineral supplement composition comprising the steps of:
(a) providing uncontaminated plant material;
(b) oxidizing by burning said uncontaminated plant material down to an ash form;
(c) reacting said ash form of said uncontaminated plant material with organic acids, resulting in a reacted form of plant ash in solid form, solution form or suspension form;
(d) isolating said reacted form of plant ash in solid form, solution form or suspension form; and
(e) processing said isolated reacted form of plant ash for the purpose of making a consumable nutritional mineral supplement composition.

2. The method of preparing a consumable nutritional mineral supplement composition according to claim 1, wherein said step of providing uncontaminated plant material further includes providing plant material free of pesticides, herbicides, fire-retardants or other chemical or environmental contamination.

3. The method of preparing a consumable nutritional mineral supplement composition according to claim 1, wherein said step of reacting said ash form of said uncontaminated plant material with organic acids further includes reacting said ash form of said uncontaminated plant material with organic acids selected from the group consisting of lactic acid, citric acid, acetic acid, malic acid, gluconic acid, saccharic acid, orotic acid, and ascorbic acid.

4. The method of preparing a consumable nutritional mineral supplement composition according to claim 1, wherein said step of reacting said ash form of said uncontaminated plant material with organic acids further includes replacing said organic acid with an inorganic acid.

5. The method of preparing a consumable nutritional mineral supplement composition according to claim 1, wherein said step of reacting said ash form of said uncontaminated plant material with organic acids further includes mixing said organic acid with an inorganic acid.

6. The method of preparing a consumable nutritional mineral supplement composition according to claim 1, wherein said step of isolating said reacted form of plant ash in solid form, solution form or suspension form further includes heating, dilution, filtration, concentration, crystallization, and evaporation.

7. The method of preparing a consumable nutritional mineral supplement composition according to claim 1, wherein said step of processing said isolated reacted form of plant ash further includes homogenization, pasteurization, sterilization, grinding and powdering.

8. A consumable nutritional mineral supplement composition prepared according to claim 1, comprising plant ash reacted with organic or inorganic acid, isolated, and processed into a solid powdered form.

9. The consumable nutritional mineral supplement composition according to claim 8, wherein said solid powdered form is compressed into pill tablets for oral consumption by humans and animals.

10. The consumable nutritional mineral supplement composition according to claim 8, wherein said solid powdered form is encapsulated into gelatin capsules tablets for oral consumption by humans and animals.

11. The consumable nutritional mineral supplement composition according to claim 8, wherein said solid powdered form is added directly to animal feeds for oral consumption by animals.

12. The consumable nutritional mineral supplement composition according to claim 8, wherein said solid powdered form is mixed with vitamins, nutraceuticals, and/or herbs for the purpose of formulating a multi-vitamin/multi-mineral supplement.

13. A consumable nutritional mineral supplement composition prepared according to claim 1, comprising plant ash reacted with organic or inorganic acid, isolated, and processed into a solution form.

14. The consumable nutritional mineral supplement composition according to claim 13, wherein said solution form is mixed with natural or artificial sweeteners, fragrances, food colorings and/or preservatives.

15. The consumable nutritional mineral supplement composition according to claim 13, wherein said solution form is fortified by addition of vitamin D₃.

16. A consumable nutritional mineral supplement composition prepared according to claim 1, comprising plant ash reacted with organic or inorganic acid, isolated, and processed into a suspension form.

17. The consumable nutritional mineral supplement composition according to claim 16, wherein said suspension form further includes an aqueous suspension.

18. The consumable nutritional mineral supplement composition according to claim 16, wherein said suspension form further includes a colloidal suspension.

19 The consumable nutritional mineral supplement composition according to claim 17, wherein said aqueous suspension form is further treated with carbon dioxide, and processed into tablet form, such that when said carbon dioxide processed tablet form is added to a liquid beverage, produces carbon dioxide gas causing the solution to effervesce, resulting in a carbonated mineral supplement in the form of a refreshing drink.

20. The consumable nutritional mineral supplement composition according to claim 19, wherein said carbon dioxide processed tablet form is added to fruit or vegetable juice.
